(19) United States
(12) Patent Application Publication
(10) Pub. No.: US 2018/0038265 A1
(43) Pub. Date: Feb. 8, 2018

(54) PISTON FOR AN INTERNAL COMBUSTION ENGINE

(71) Applicant: Mahle International GmbH, Stuttgart (DE)

(72) Inventor: Joachim Schmidt, Stuttgart (DE)

(21) Appl. No.: 15/553,979

(22) PCT Filed: Feb. 26, 2016
(86) PCT No.: PCT/EP2016/054104

§ 371 Date: Aug. 25, 2017

(30) Foreign Application Priority Data
Feb. 26, 2015 (DE) 10 2015 002 322.5

(51) Int. Cl. F01P 3/10; F02F 3/22

(52) U.S. Cl. CPC F01P 3/10; F02F 3/22

(57) ABSTRACT

A piston for an internal combustion engine may include a piston head and a piston skirt. A circumferential ring belt may be arranged in the piston head and may include ring grooves for receiving piston rings. A circumferential cooling duct may be in the piston head which may be on a level with the circumferential ring belt and may include inlet openings and outlet openings for cooling oil. At least one cavity for receiving cooling oil, which opens into the cooling duct, may be provided at least in an area of an inlet opening for cooling oil.

### CROSS-REFERENCE TO RELATED APPLICATION

This application claims priority to International Patent Application No. PCT/EP2016/054104 filed on Feb. 26, 2016, and German Patent Application No. 10 2015 002 322.5 filed on Feb. 26, 2015, the contents of which are hereby incorporated by reference in their entirety.

### TECHNICAL FIELD

The present invention relates to a piston for an internal combustion engine, having a piston head and a piston skirt, having a circumferential ring belt arranged in the piston head and comprising ring grooves for receiving piston rings, and a circumferential cooling duct in the piston head which is on a level with the ring belt and which has inlet openings and outlet openings for cooling oil.

### BACKGROUND

Pistons of the generic type are known. A characteristic feature of modern pistons is their small overall height, giving them a small compression distance. For this reason an effective cooling of the piston by means of cooling oil during engine operation is ever more difficult to achieve, since less and less space is available for a functional cooling duct.

### SUMMARY

The object of the present invention is to develop a piston of the generic type so as to achieve improved cooling by means of cooling oil.

This is achieved in that a cavity for receiving cooling oil, which opens into the cooling duct, is provided at least in the area of an inlet opening for cooling oil.

A characterizing feature of the piston according to the invention is that an additional shaker effect is obtained in the area of at least one inlet opening for cooling oil, since the cooling oil is free to move in the cavity provided according to the invention and during engine operation is moved up and down in the cavity due to the reciprocating movement of the piston. This results in an improved heat transfer from the piston head towards the piston skirt, where the heat is dissipated over a large area.

Advantageous developments emerge from the dependent claims. The height (H) of the cavity and the height (h) of the cooling duct are preferably designed with a ratio of 5:2 to one another, in order to obtain an optimum improvement in the heat transfer.

In a further advantageous development the cross sectional area (Q) of the cavity and the cross sectional area (q) of the cooling duct are designed with a ratio of 4:1.2 to 4:1.5 to one another. This measure also serves to achieve an optimum heat transfer.

The piston according to the invention advantageously has a major thrust face (DS) and a minor thrust face (GDS), wherein an inlet opening for cooling oil is provided in the area of the major thrust face (DS) and in the area of the minor thrust face (GDS). If both inlet openings are provided with a cavity according to the invention, the quantity of heat produced during engine operation is dissipated even more efficiently.

The cooling duct may comprise additional bored holes and/or fins for controlling the retention time of the cooling oil received in the cooling duct.

The compression distance KH of the piston according to the invention is preferably 30 to 35 mm, preferably 32 mm, making such a piston suitable for use in automotive racing.

For weight-saving reasons the piston according to the invention is preferably embodied as a full slipper skirt piston. In this case the piston bosses provided in the piston skirt and equipped with center bores are provided with reinforcing ribs, in order to increase the inherent rigidity of the piston.

The piston according to the invention is preferably made from an aluminum-based material, in order to further reduce the moving mass of the piston during engine operation.

The piston according to the invention may be made up of a piston upper part and a piston lower part, in order to optimize the choice of materials suited to the piston loads in engine operation. In this case the piston upper part and the piston lower part are preferably firmly connected together by means of a high temperature-resistant epoxide- or ceramic-based adhesive. The joining seam between the piston upper part and the piston lower part is preferably arranged between the first ring groove and the second ring groove of the ring belt.

### BRIEF DESCRIPTION OF THE DRAWINGS

An exemplary embodiment of the present invention is described in more detail below, referring to the drawings attached. In a schematic representation, not to scale:

FIG. 1 shows an exemplary embodiment of a piston according to the invention, in section along the line I-I in FIG. 4;

FIG. 2 shows a section along the line II-II in FIG. 1;

FIG. 3 shows a section along the line in FIG. 1;

FIG. 4 shows a top view of the piston according to FIG. 1.

### DETAILED DESCRIPTION

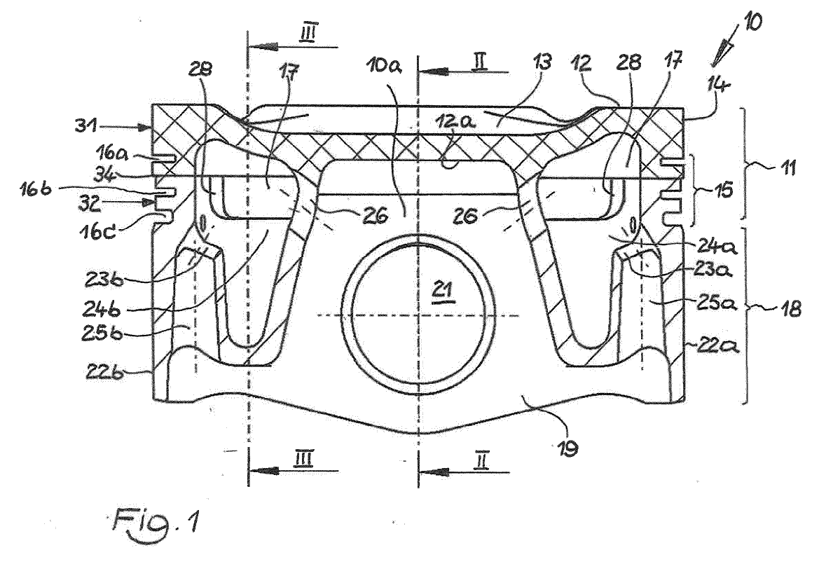

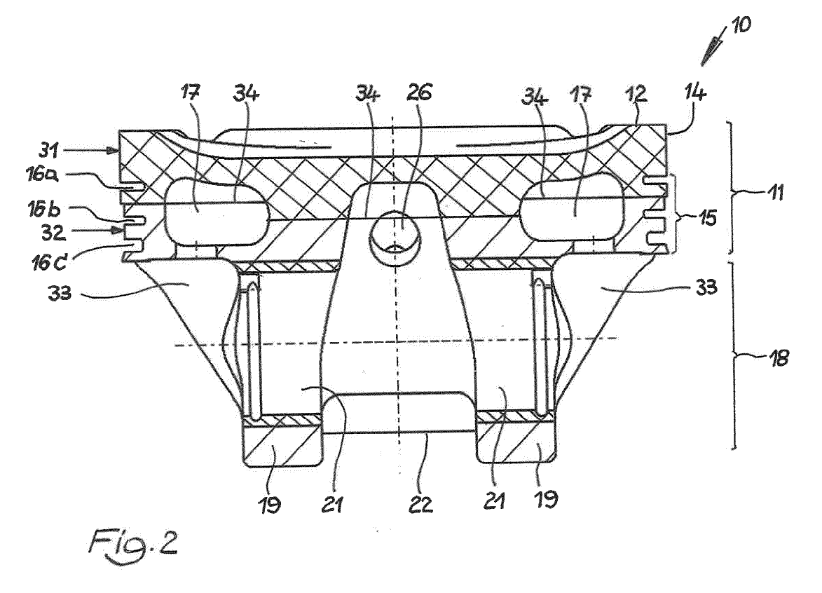

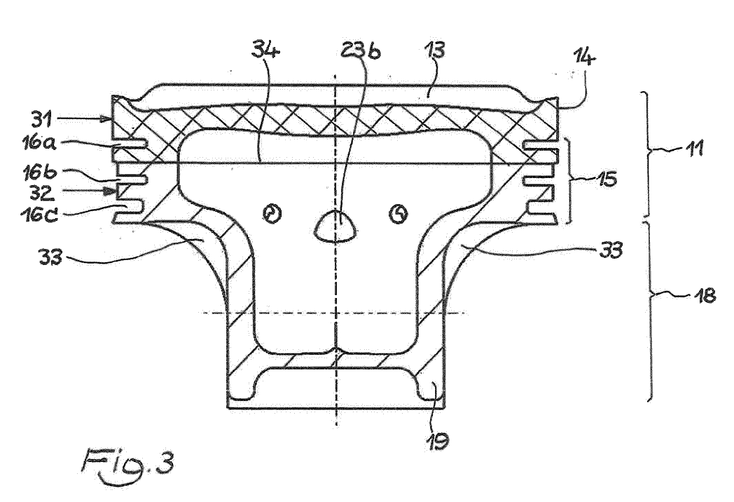

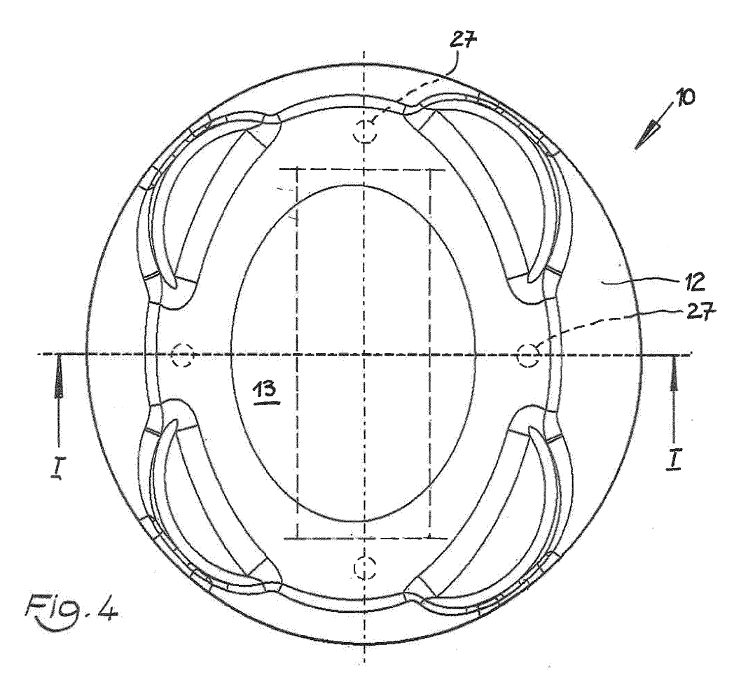

FIGS. 1 to 4 show an exemplary embodiment of a piston 10 according to the invention. The piston 10 in the exemplary embodiment is embodied as a full slipper skirt piston. The piston 10 comprises a piston head 11 having a piston crown 12, a combustion recess 13, a circumferential piston top land 14 and a circumferential ring belt 15 having ring grooves 16a, 16b, 16c for receiving piston rings (not shown). A circumferential cooling duct 17 is provided on a level with the ring belt.

The piston 10 further comprises a piston skirt 18, which in a manner known in the art is provided with piston bosses 19, into which center bores 21 are introduced for receiving a piston pin (not shown). The piston bosses 19 are connected to one another via bearing surfaces 22a, 22b.

In its interior space 10a the exemplary embodiment representative of the piston 10 according to the invention has a cavity 24a, 24b on each face, on its major thrust face DS and on its minor thrust face GDS, which are defined by its bearing surfaces 22a, 22b. Each cavity 24a, 24b is provided with an inlet opening 23a, 23b for cooling oil (cf. FIG. 1). Each cavity 24a, 24b extends into the interior space 10a of the piston 10 in the direction of the piston bosses 19 and opens into the circumferential cooling duct 17 in the area of the piston head 11. The outside wall of each cavity 24a, 24b and the inside wall of the bearing surface 22a, 22b associated therewith form an inlet funnel 25a, 25b for cooling oil, which opens into the respective cavity 24a, 24b via the corresponding inlet opening 23a, 23b (cf. FIG. 1).

According to the invention the cavities 24a, 24b act as shaker cavities, in which the cooling oil, in a manner known in the art, is moved up and down during engine operation (so-called “cocktail-shaker effect”). According to the invention this results in improved heat removal from the region of the piston head 11 towards the piston skirt 18, where the heat is dissipated via the bearing surfaces 22a, 22b.

In the exemplary embodiment represented the height H of each cavity 24a, 24b and the height h of the cooling duct 17 are preferably designed with a ratio of 5:2 to one another, for example. In the exemplary embodiment the cross sectional area (Q) of each cavity 24a, 24b and the cross sectional area (q) of the cooling duct 17 are designed with a ratio of 4:1.35, for example.

In a manner known in the art, the cooling duct 17 in the exemplary embodiment representative of a piston according to the invention comprises outlet openings 26 for cooling oil, through which the cooling oil is fed in the direction of the interior space 10a of the piston 10. This serves on the one hand for additional cooling of the underside 12a of the piston crown 12 and on the other for additional lubrication of the center bores 21 and of the piston pin received therein during engine operation.

In a manner known in the art, the cooling duct 17 in the exemplary embodiment representative of a piston 10 according to the invention further comprises additional bored holes 27 and fins 28 for controlling the retention time of the cooling oil received in the cooling duct 17 during engine operation.

The exemplary embodiment of the piston 10 according to the invention represented in the figures is formed from a piston upper part 31 and a piston lower part 32, which are preferably made from an aluminum-based material and are firmly connected together by means of a high temperature-resistant (up to 300° C.) epoxide resin- or ceramic-based adhesive. In the exemplary embodiment the joining seam 34 between the piston upper part 31 and the piston lower part 32 is arranged between the first ring groove 16a and the second ring groove 16b.

In the exemplary embodiment the piston 10 has a compression distance KH of 32 mm and in this design is suitable for use in automotive racing.

For additional stabilization and reinforcement of the piston 10, the piston bosses 19 comprise reinforcing ribs 33 in the area of the piston bosses 21. The reinforcing ribs 33 brace the piston head 11 relative to the piston bosses 19 in the area below its ring belt 15, in such a way that the risk of deformations of the piston head 11 in the area of ring belt 15 is at least reduced during engine operation.

1. A piston for an internal combustion engine comprising:
a piston head and a piston skirt, a circumferential ring belt arranged in the piston head and including a plurality of ring grooves constructed and arranged to receive piston rings, a circumferential cooling duct disposed in the piston head at a position level with the circumferential ring belt, the circumferential cooling duct having inlet openings and outlet openings for cooling oil, and at least one cavity for receiving cooling oil provided at least in an area of at least one of the inlet openings for cooling oil, wherein the at least one cavity opens into the circumferential cooling duct.

2. The piston as claimed in claim 1, wherein a height of the at least one cavity and a height of the cooling duct define a ratio of 5:2 to one another.

3. The piston as claimed in claim 1, wherein a cross sectional area of the at least one cavity and a cross sectional area of the cooling duct define a ratio of 4:1.2 to 4:1.5 to one another.

4. The piston as claimed in claim 1, wherein the piston has a major thrust face and a minor thrust face, and wherein at least one of the inlet openings for cooling oil is provided in an area of the major thrust face and at least one other of the inlet openings for cooling oil is provided in an area of the minor thrust face.

5. The piston as claimed in claim 1, wherein the cooling duct includes at least one of bored holes and fins constructed and arranged to control a retention time of the cooling oil received in the cooling duct.

6. The piston as claimed in claim 1, wherein the piston head and the piston skirt together define a compression distance of 30 to 35 mm.

7. The piston as claimed in claim 1, wherein the piston is a full slipper skirt piston.

8. The piston as claimed in claim 7, further comprising piston bosses having center bores provided in the piston skirt and reinforcing ribs provided in an area of the piston bosses.

9. The piston as claimed in claim 1, wherein the piston head and the piston skirt are composed of an aluminum-based material.

10. The piston as claimed in claim 1, wherein the piston head and the piston skirt together define a piston upper part and a piston lower part.

11. The piston as claimed in claim 10, wherein the piston upper part and the piston lower part are firmly connected together via at least one of a high temperature-resistant epoxide-based adhesive and a high temperature-resistant ceramic-based adhesive.

12. The piston as claimed in claim 10, further comprising a joining seam arranged between a first ring groove and a second ring groove of the circumferential ring belt.

13. The piston as claimed in claim 10, further comprising a joining seam between the piston upper part and the piston lower part.

14. The piston as claimed in claim 1, wherein the piston head and the piston skirt define an interior space, a major thrust face, and a minor thrust face, and wherein the at least one cavity includes a first cavity defined by a first bearing surface on the major thrust face and a second cavity defined by a second bearing surface on the minor thrust face, and wherein the first cavity comprises a first inlet opening of said inlet openings and the second cavity comprises a second inlet opening of said inlet openings, and wherein the first cavity and the second cavity extend into the interior space.

15. A piston for an internal combustion engine comprising:
a piston head and a piston skirt;
a circumferential ring belt arranged in the piston head and including ring grooves for receiving piston rings;
a circumferential cooling duct disposed in the piston head at a position level with the circumferential ring belt, the cooling duct having a plurality of inlet openings and a plurality of outlet openings for cooling oil; and
at least one cavity for receiving cooling oil provided in an area of at least one of the plurality of inlet openings for cooling oil, the at least one cavity opening into the cooling duct;
wherein a height of the at least one cavity and a height of the cooling duct define a ratio of 5:2 to one another, and wherein a cross sectional area of the at least one cavity and a cross sectional area of the cooling duct define a ratio of 4:1.2 to 4:1.5 to one another.

16. The piston as claimed in claim 15, wherein the piston head and the piston skirt define a major thrust face and a minor thrust face, and wherein at least one of the plurality of inlet openings is provided in an area of the major thrust face and at least one other of the plurality of inlet openings is provided in an area of the minor thrust face.

17. The piston as claimed in claim 15, wherein the cooling duct includes bored holes constructed and arranged to control a retention time of the cooling oil received in the cooling duct.

18. The piston as claimed in claim 15, wherein the cooling duct includes fins constructed and arranged to control a retention time of the cooling oil received in the cooling duct.

19. The piston as claimed in claim 15, wherein the piston head and the piston skirt together define a compression distance of 30 to 35 mm.

20. The piston as claimed in claim 15, wherein piston bosses having center bores are provided in the piston skirt and reinforcing ribs are provided in an area of the piston bosses.
